(19) United States
(12) Patent Application Publication
(10) Pub. No.: US 2014/0088857 A1
(43) Pub. Date: Mar. 27, 2014

(54) VIDEO-GRAPHIC RUNWAY ACTIVITY MONITORING SYSTEM

(71) Applicant: James Theodore Hollin, JR., Tyrone, GA (US)

(72) Inventor: James Theodore Hollin, JR., Tyrone, GA (US)

(21) Appl. No.: 14/027,190

(22) Filed: Sep. 14, 2013

Related U.S. Application Data
(60) Provisional application No. 61/701,132, filed on Sep. 14, 2012.

(51) Int. Cl. G08G 5/06; G08G 5/00

(52) U.S. Cl. CPC G08G 5/06; G08G 5/0043
USPC 701/120

(57) ABSTRACT

Disclosed is a system for detecting and displaying airplane and/or vehicular activity on an airport runway or its intersecting taxi ways and providing an indication of such activity to the crew of an on-ground aircraft operating upon or approaching the same active runway or taxiway. The system relies on a plurality of LCD, LED, or other electronic monitors which display a video image of the runway, taxiway, or intersection immediately adjacent to the location of the monitor. Any discernable aircraft or vehicular traffic operating on the subject runway or taxiway is displayed by icons (mechanical or electronic image) against the runway/taxiway background on the monitor. The monitor is powered by instantaneous feeds from any combination of all or a variety of sources, including ground control radar returns. Airport Surface Detection Equipment (ASDE-X), Automatic Dependent Surveillance-Broadcast (ADS-B), aircraft transponders, air traffic controller stations, satellite transmissions, and other equipment.

### CROSS-REFERENCES TO RELATED APPLICATIONS

This application, claims the benefit of priority from U.S. Provisional application No. 63/701,132 filed on Sep. 14,2012 and said provisional application is incorporated fully herein as though appearing as part of this current application.

### STATEMENT REGARDING FEDERALLY SPONSORED RESEARCH OR DEVELOPMENT

There is no federally sponsored research or development in conjunction with this invention.

### NAMES OF THE PARTIES TO A JOINT RESEARCH AGREEMENT

There is no joint research agreement involved with this invention.

### BACKGROUND OF THE INVENTION

(1) Field of the Invention.

This inventive concept relates to the issue of airport safety. In particular, the inventive concept discloses devices intended to provide visually displayed graphic images on a plurality of monitors located near runway and/or taxi way intersections. The monitors will present displays easily seen by a pilot or an aircrew actively operating an aircraft on the airport surface. The displays will give these crews accurate and instantaneous indications of the proximity of vehicles or other aircraft occupying or approaching a runway or taxiway proximate the crew member's aircraft.

After the Wright brothers first flew a powered airplane in the United States, on Dec. 17, 1903, multiple aircraft eventually began occupying the skies near American airports. As a natural consequence, the possibility of two airplanes colliding with each other either while airborne or during ground operations increased. Indeed, there have been numerous collisions and “near misses” of aircraft during ground operations over the past 50 years. These accidents and incidents are routinely termed as “runway incursions.” The most severe of these type accidents was the collision in March 1977, of two Boeing 747 aircraft on a runway in Tenerife, Canary Islands, in which 583 people perished.

Reducing the potential for accidents occurring on runways and taxiways is a top priority of the Federal Aviation Administration (FAA), One of the prime FAA goals is to reduce the severity and frequency of runway incursions through the mitigation of errors that contribute to the risk of collision. In its Executive Summary of runway safety published in October, 2007, the FAA outlined its plans to reduce runway incursions by “implementing a combination of technology, infrastructure, procedures, and training intervention strategies to decrease human errors and increase the error tolerance of airport surface movement operations.” The prime objective of this inventive concept is to provide aircrews with effective devices and methods which present instantaneous displays, information, and warnings concerning potential risks of runway or taxiway collision.

(2) Description of the Related Art, including information disclosed under 37 CFR 1,97 and 1.98, The following documents disclose similar features and functions in comparison to the present inventive concept,

U.S. Pat. No. 8,457,812) A method and system for resolving existing and potential traffic conflicts that may occur during take-off and landing in aviation that includes means of monitoring movements on the runway, its approaches and environs to determine whether a conflict or potential conflict exists, means to resolve a conflict and to generate an output pertaining to this resolution.

U.S. Pat. No. 8,401,774 A method for predicting the occurrence of an undesired operating event for a mobile platform operating within a designated area. The method may involve obtaining a plurality of parameters including a position of the mobile platform within the designated area for determining a kinematic motion of the mobile platform while the mobile platform is operating within the designated, area. The kinematic motion of the mobile platform and the physical constraints may be used to predict if motion of the mobile platform will cause it to incur an undesired operating event.

U.S. Pat. No. 7,647,180 A system for preventing vehicle accidents at intersections includes a positioning system arranged in a vehicle for determining the absolute position thereof, a memory unit within the vehicle for storing data relating to edges of at least one lime of the roadway on which the vehicle may travel and the edges of at least one intersecting lane at an intersection, a receiver arranged in the vehicle for receiving position information about another vehicle in an intersecting lane, a processor coupled to the positioning system, the receiver and the memory unit for predicting a collision between the vehicles.

U.S. Pat. No. ,479,925 Disclosed are systems and methods for avoiding runway collisions includes a position-sensing device that is operable to determine a position of the aircraft, and a communications system operable to support two-way communications between the aircraft and other similarly configured aircraft. A collision avoidance processor is coupled to the position-sensing device and the communications system that is configured to generate a message if the aircraft moves into a restricted zone positioned proximate to the airport.

U.S. Pat. No. 7,206,698 A method, computer program product, and apparatus for locating aircraft with respect to airport runways and environs, thereby presenting a graphical display of the aircraft position, heading and ground speed information relative to the aircraft runways and environs, and annunciating situational awareness advisories as a function of aircraft information relative to the airport, runways and environs.

U.S. Pat. No. 7,117,089 A Ground Runway Awareness and Advisory System (GRAAS) that provides supplemental position information and. airport situational awareness alerts and advisories to pedestrians and vehicle operators during surface operations by providing timely aural, textual graphic or pictographic alerts and advisory messages to pedestrians and vehicle operators in a significant number of different scenarios that have led to past runway and taxiway incursion occurrences. These messages are optionally supplemented by a situational awareness video display.

U.S. Pat. No. 6,789,010 The system discloses an airport map display which provides situational awareness to a pilot of an airport's runways, taxiways, and other features relative to the pilot's aircraft. Data representative of an airport map is translated and communicated between aircraft systems using a data interchange method that facilitates efficient throughput of information-n used to represent an airport map. In addition, data representative of taxi routes, modified taxi routes, and current position of the aircraft at the airport are also translated and communicated using a compact data interchange method.

U.S. Pat. No. 6,606,563 A. system for alerting the occupant of a vehicle that, the vehicle is in or approaching a zone of awareness. For instance, the system maybe used to alert the pilot or flight crew of an aircraft that the aircraft is on or approaching a runway, and may identify the specific runway. The system generally includes a storage device or memory, a positioning system such as a GPS that typically repeatedly determines the location of the vehicle, an alerting device such as an alarm or display, and a processor, all of which are typically located on the vehicle.

### SUMMARY OF THE INVENTION

The present inventive concept discloses a system and associated devices for detecting, synthesizing, arid displaying airplane and/of vehicular activity on an airport runway or taxiway by means of monitors at key locations on the airport environment. The inventive concept is entitled Visual-Graphic Runway Activity Monitoring System, or “VRAMS.” Inputs to the detection, and/or display monitoring equipment maybe a combination of (1) radar images relayed and/or fed from the airport ground control radar antennas and/or Air Traffic Control (ATC) controller consoles, (2) transponder returns of aircraft in the immediate operating area of the active runway or intersecting taxiway(s), (3) images transmitted from satellites orbiting above the earth, and/or (4) other runway/taxiway activity sensing devices currently in use or that may be developed for future use as airport safety monitoring systems.

In the preferred embodiment, the display parameters for the monitors with respect to aircraft utilizing an active runway are predicated on aircraft positions and movement (a) within 300 feet vertically and 100 feet horizontally of the centerline of the departure and approach ends of the active runway, (b) on the surface of said active runway, and/or (c) on any taxiway proximate the intersection of the taxiway and the active runway.

The VRAMS monitoring devices may be an LCD, LED, or other suitable electronic or mechanical displays. The monitors must be adequately insulated, sealed, and suitable for outdoor all-weather operation. The monitoring devices are placed at the various locations of intersection of runway/runway, runway/taxiway, and as deemed necessary, taxiway/taxiway intersections. The detection and monitoring devices are suitable for use at both civilian and military airports and airfields.

in its preferred embodiment, the system will be in active operation within certain modes and defined parameters of runway/taxiway activity, including, but not limited to, (1) an aircraft accelerating on takeoff roll, (2) an aircraft descending on landing approach and below three hundred (300′) feet above touchdown zone, (3) an aircraft on lauding rollout, and (4) during normal aircraft taxi maneuvers when an aircraft approaches within one hundred feet (100′) of a taxiway/runway intersection. When the system is in the activation mode, the monitored runway and its intersecting taxiways will be displayed. Further, a video display incorporating an icon representing the object which is the subject of the signal to the monitor will he displayed against a graphically-displayed (electronic or mechanical) backdrop of the monitored runway or taxiway.

As an additional feature, aircraft cockpit instrumentation may be designed and/or adapted to receive repeater displays of the same indications presented on the monitor most proximate the aircraft. Such duplicate displays will further be capable of presenting to the aircrew either a visual or oral warning of the object, generating the displayed icon. The instrumentation may indicate the range, altitude, speed differential, and orientation of the object, and simultaneously give other pertinent information related to those indications of runway/taxiway activity. The disclosed system and instrumentation may also he designed to simultaneously provide a proximity warning to the air traffic controller, tower controller, or ground controller monitoring the specific runway.

### BRIEF DESCRIPTION OF THE VIEWS OF THE DRAWINGS

FIG. 1 depicts a cockpit view of the intersection of an airport taxiway and Runway 28-10, with the VRAMS monitors shown.

FIG. 2 presents a side view of a transport category jet aircraft approaching an intersection at which a VRAMS monitor is positioned.

FIG. 3 displays an overhead view of the intersection of the approach end of Runway 28 with a north-south taxiway, and further depicts two VRAMS monitors on each respective side of the approach end.

FIG. 4 shows the VRAMS monitor of FIG. 3, as would be seen from the cockpit of a taxiing aircraft approaching hypothetical runway 28-10, from the north side of the runway.

FIG. 5 displays a VRAMS monitor with a graphic layout of runway 10-28, as would be seen from the cockpit of a taxiing aircraft approaching that runway from the south side of the runway.

FIG. 6 is an overhead view of the runway-taxiway layout for runway 10-28 further showing the locations of a plurality of VRAMS monitors at various taxiway/runway intersections.

FIG. 7 is an overhead view of the runway-taxiway layout for runway 28-10 further showing the locations of a plurality of VRAMS monitors at various taxiway/runway intersections.

Nomenclature for Components of Inventive Concept

```
  1. VRAMS Monitor
  2. Runway icon
  3. Runway approach end
  4. Approaching aircraft icon
  5. Landing roll aircraft icon
  6. Vehicle icon
  7. Runway designator
  8. Runway identification sign
  9. Cockpit
10. Aircrew line-of-sight
11. Aircraft
12. n/a
13.Taxiway
14. Overrun
15. Runway 28-10
16. Runway 10-28
17. Hold short lines
18.-19. n/a
20. Monitor at taxiway F
21. Monitor at taxiway E
22. Monitor at taxiway D
23. Monitor at taxiway C
24. Monitor at taxiway B
25. Monitor at taxiway A
26. Monitor at taxiway M
27. Monitor at taxiway L
28. Monitor at taxiway K
29. Monitor at taxiway J
30. Monitor at taxiway H
31. Monitor at taxiway G
32.-39. n/a
40. Taxiway A
41. Taxiway B
42. Taxiway C
43. Taxiway D
44. Taxiway E
45. Taxiway F
46. Taxiway G
47. Taxiway H
48. Taxiway J
49. Taxiway K
50. Taxiway L
51. Taxiway M
```

### DETAILED DESCRIPTION

For the sake of convenience and clarity, the system disclosed will be depicted as an operational system at an airport which utilizes a hypothetical Runway 28-10 15. As is standard procedure in the aviation industry, this Runway 28-10 15 can be used

for takeoffs and landings in either a 280 degree magnetic direction or a 100 degree magnetic direction, depending on the prevailing wind at the airport. For instance, should the airport winds be blowing from an easterly direction, aircraft takeoffs and landings would be conducted on Runway 10.

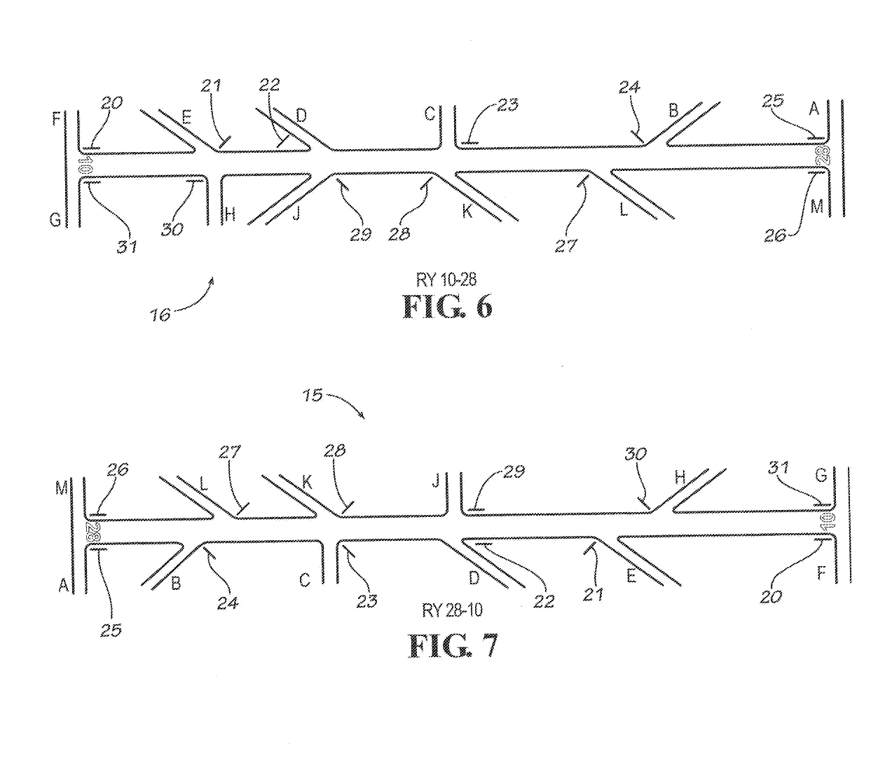

It should be noted that, at the particular point in lime presented in this disclosure, the control tower is in the process of changing the active runway from Runway 10 to Runway 28, due to a change in the wind conditions at the hypothetical airport. The following scenarios are predicated on the imminent change of active runways. An essential feature of the inventive concept is that all VRAMS monitors (26-31.) at taxiway intersections with the south side of runway 10-28 16 will give the same VRAMS monitor presentation as is illustrated in FIG. 5. In the airport layout, these monitors are shown in both FIG. 6 and FIG. 7.

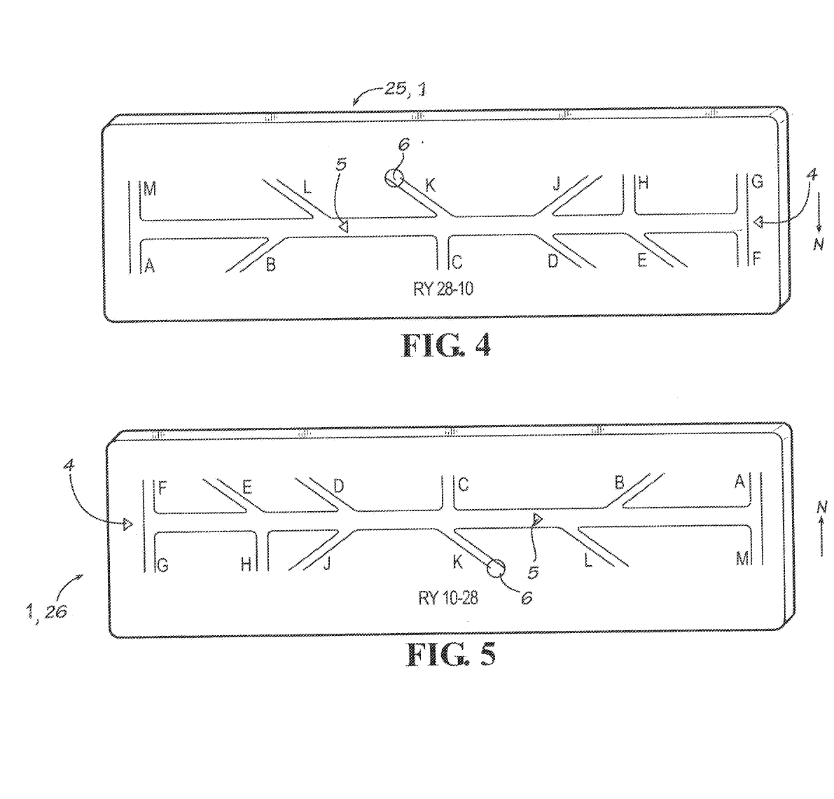

Conversely, all VRAMS monitors (20-25) located at intersections of taxiways with the north side of runway 10-28 16 will give the same VRAMS presentation as illustrated in FIG. 4. Two overhead runway views are also presented, being FIG. 6, presenting Runway 10-28 16 as seen with magnetic north being oriented toward the top of the drawing sheet, and FIG. 7, presenting Runway 28-10 15 as seen with magnetic north being oriented toward the bottom of the drawing sheet.

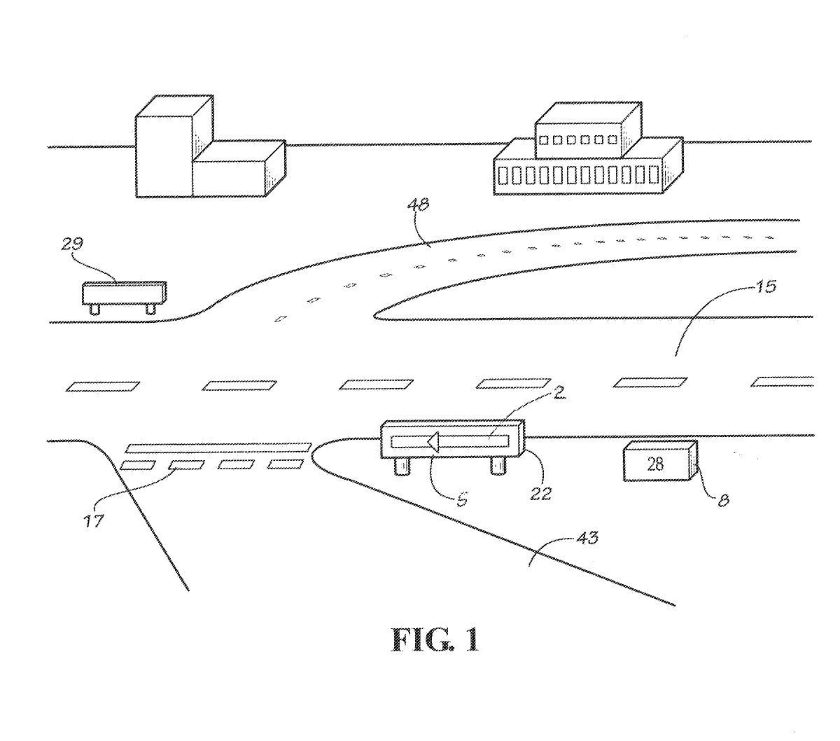

Beginning with FIG. 1, there is presented a generalized view of the intersection of taxiway D 43 and runway 28-10 15. The view represents what would be seen by-aircrew members from the cockpit of an aircraft taxiing on taxiway D 43 heading toward Runway 28-10 15. Further, there is shown a VRAMS monitor 22 positioned just prior to, and parallel to Runway 28-10 15. An overhead view of this runway scenario would be depicted in FIG. 7, which shows the general west-to-east orientation and layout of Runway 28-10 15. in referring to FIG. 7, there is also depicted the VRAMS monitor 22 positioned proximate taxiway D 43 prior to the intersection of taxiway D 43 with Runway 28-10 15.

On the other hand, should there be an aircraft on taxiway J 48 taxiing toward. She intersection with Runway 28-10, a VRAMS monitor 29 is shown positioned for visual runway advisories to the crew. The VRAMS monitor 29 positioned at taxiway J 48 would present a display as shown, in FIG. 5. This display corresponds to an overhead view of the actual runway as illustrated in FIG. 6.

The VRAMS monitor 22 illustrated in FIG. 1 is shown in more detail in FIG. 4. FIG. 4 shows that VRAMS monitor 22 indicates an electronic, digitalized presentation, of runway/taxiway information for Runway 28-10 15, in particular, the general west-to-east orientation of the runway 15 and all intersecting taxiways. The taxiways include G 46, H 47, J 48, K 49, L 50, M SI, all on the on the south side of Runway 28-10 15. The north side of Runway 28-10 15, as shown on the monitor, depicts taxiways A 40, B, 41, C 42, D 43, E 44, and F 45, For the sake of clarity, and to avoid a prolusion of numbered callouts, in FIGS. 4, 5, 6, and 7, the airport taxiways (A through M) (40-51) are depicted without their respective numbered callouts.

All the VRAMS monitors (20-31) must be constructed of a size of sufficient dimensions to display the electronic information in an easily readable format for cockpit crewmembers. Initial estimates indicate that a reasonable size for the monitors (20-31) would be approximately 6 feet horizontally by 2 feet vertically.

In FIG. 1 there is also shown, on the far side or Runway 28-10 15, a VRAMS monitor 29 adjacent to taxiway J 48. This monitor 29 presents runway-taxiway information to aircraft taxiing southbound on taxiway J 48 and approaching Runway 10-28 16 from the north side of the airport. The VRAMS monitor 29 would present an inverted view of the runway/taxiway layout shown on VRAMS monitor 22. In. viewing the airport diagram in FIG. 7, it is seen that the VRAMS monitor 29 is placed proximate the intersection of taxiway J 48 to provide runway/taxiway information for aircraft approaching the runway while taxiing northeast bound on taxiway J 48, As is standard U.S. airport signage, and in conformance with die exact depiction of magnetic compass orientation, the VRAMS monitor 29 at taxiway J 48 displays the associated runway as Ron way 10-28 16. The detailed display of VRAMS monitor 29 would be as shown in FIG. 5.

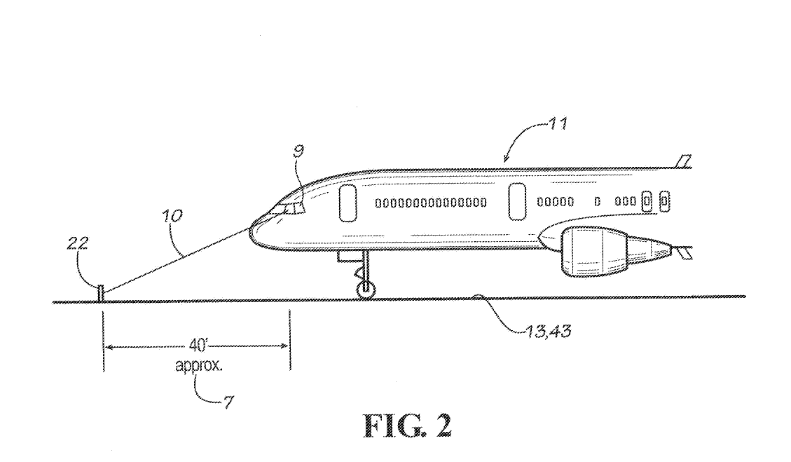

Turning to FIG. 2, there is depicted a view of the left side of a transport category jet aircraft 11 taxiing on taxiway D 43 as it approaches the intersection of runway 28-10 15, at which a VRAMS monitor 22 is located. Through the cockpit 9 of the aircraft 11, the line of sight 10 of both front seat crewmembers enables them to see the VRAMS monitor 22 located to the right side of taxiway D 43. However, at closer than a forty feet ground distance 7, from the monitor 22 to the cockpit 9, the crewmember on the opposite side of the cockpit 9 from the VRAMS monitor 22 may not be able to see the monitor.

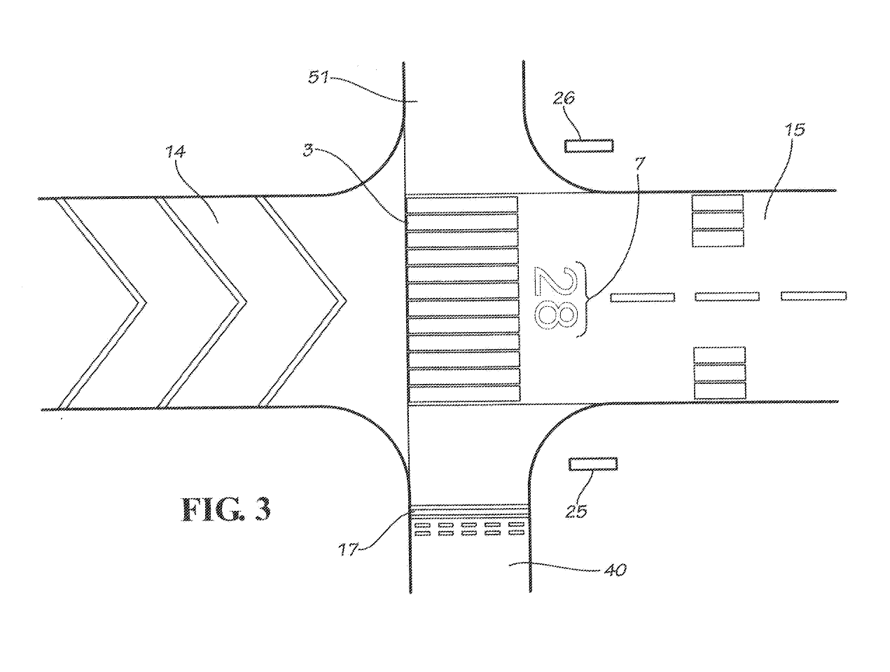

In FIG 3 there is displayed a close-up overhead view of the approach end 3 of Runway 28 15. Further, there is shown a south taxiway M 51, a north taxiway A 40, the runway overrun 14, and the runway designator “28” 8. Additionally there are shown two VRAMS monitors 26 and 25, on the south side and north side of the approach end 3, respectively. For illustrative purposes, using FIG. 3 as the setting, it is assumed an aircraft is taxing southbound on taxiway A 40 just prior to the runway approach end 3. Air traffic control regulations require that the aircraft stop at the hold short lines 17 unless the aircraft has been cleared by the tower to cross runway 28 or pull onto the runway for takeoff preparation. Should the aircraft come to a stop, VRAMS monitor 25 would display to the aircraft crewmembers a presentation essentially as shown in FIG. 4.

In the preceding situation, it is further assumed that the prevailing winds are relatively calm but shifting more to a westerly direction. Therefore, the control tower is making preparations to change the operational runway to Runway 28 15. However, an aircraft has just landed on Runway 10 16 and is in its landing rollout, preparing to exit the runway at taxiway L This is more clearly shown, by the VRAMS monitor 25 in FIG. 4, where the aircraft, in the rollout phase is depicted as a triangular-shaped icon 5. Further, it is assumed that there is another aircraft approaching on “short final” for Runway 10 16. The approaching aircraft is represented by a triangular icon 4 as shown in FIG. 4. The approaching aircraft, represented by the icon 4, is within one statute mile of the approach end of Runway 10 16 and is also below three hundred feet above the runway touchdown zone, which conditions are within the display parameters of all VRAMS monitors.

As discussed earlier, FIG. 1 presents a generalized view of the intersection of taxiway D 43 and Runway 28-10 15. For illustrative purposes it is assumed that there is a taxiing aircraft moving on taxiway D 43 just prior to its intersection with Runway 28-10 15. The crew members in the cockpit of the second taxiing aircraft would have visual contact with VRAMS monitor 22. The pending arrival of the airborne aircraft on short final (icon 4) and the aircraft in its landing rollout (icon 5) are concurrent with the situation. The airport location of the taxiway D 43 and the VRAMS monitor 22 are also as shown in the overhead runway view in FIG. 7. The VRAMS monitor 22 would present a depiction of runway activity as shown in FIG. 4.

A different embodiment of the inventive concept may also receive information as to land vehicles 6 operating on the airport environs, particularly on any active runway or at taxiway intersections with an active runway. In viewing FIG. 4, a service vehicle, fire truck, or other motorized land vehicle is represented on. any of VRAMS monitors 20-25 (taxi ways intersecting the north side of Run way 28-10 15) by an icon 6. Specifically, the land vehicle is indicated to be on taxiway K near its intersection with Runway 10-28 16. Conversely, for aircraft operating on taxiways intersecting the south side of Runway 10-28 16) the vehicle is represented by the same icon 6 on each of VRAMS monitors 26-31, as is indicated in FIG. 5.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of in combination with, or in addition to features already disclosed herein. Accordingly, it is intended that this inventive concept be inclusive of such variations, changes, and substitutions, and by no means limited by the scope of the claims presented herein.

What is claimed is

1. An electronic processing apparatus and system for detecting and displaying aircraft positions and movement occurring (a) within a certain distance, vertically and horizontally, of the centerline of the departure and approach ends of an active runway, (b) On the surface of any active runway, and (c) on any taxiway proximate the intersection of the taxiway and any active runway, said system comprising
a first computer with an electronic database having stored data defining each runway and taxiway dimensions, locations, and orientations for a specific airport and having a means for generating a graphical depiction of a specific runway and its intersecting taxiways;
a second computer having a means for receiving, comparing, and synthesizing signals indicating the position of an aircraft, said signals received from a plurality of sources, including but not limited to ground, control radar, tower control radar. Airport Surface Detection Equipment (ASDE-X), Automatic Dependent Surveillance-Broadcast (ADS-B), aircraft transponders, air traffic controller stations, satellite transmissions, and other equipment to be developed;
a processor, located at a central on-airport facility, being configured with a means for receiving and transforming the synthesized signals received by said second computer into electronic or graphic images displayable on a monitor; and
a plurality of monitors electronically and/or electrically coupled to said processor, the monitors being located proximate the intersections of a specific runway and its associated taxiways, and if existent, the intersection of the runway with other runways, said monitors easily visible and readable by pilots of taxiing aircraft.

2. An electronic processing apparatus and system for detecting and displaying aircraft positions and movement occurring (a) within 300 feet vertically and 100 feet horizontally of the centerline of the departure and approach ends of an active runway, (b) on the surface of any active runway, and (c) on any taxiway proximate the intersection of the taxiway and any active runway, said system comprising
a first computer with an electronic database having stored data defining each runway and taxiway dimensions, location, and orientation for a specific airport and having a means for generating a graphical depiction of a specific runway and its intersecting taxiways;
a second computer having a means for receiving, comparing, and synthesizing signals indicating the position of an aircraft, said, signals received from, a plurality of sources, including but not limited to ground control radar, tower control radar. Airport Surface Detection Equipment (ASDE-X), Automatic Dependent Surveillance-Broadcast (ADS-B), aircraft transponders, air traffic controller stations, satellite transmissions, and other equipment;
a processor, located at a central on-airport facility, being configured with a means for receiving and transforming the synthesized signals received by said second computer into electronic or graphic images displayable on a monitor; and
a plurality of monitors electronically and/or electrically coupled to said processor, the monitors being located proximate the intersections of a specific runway and its intersection with its associated taxiways and if existent, the intersection of the runway with other runways, said monitors easily visible and readable by pilots of taxiing aircraft.

3. An electronic processing apparatus and system for detecting and displaying aircraft and/or vehicular positions and movement occurring (a) within a certain distance, vertically and horizontally, of the center line of the departure and approach ends of an active runway, (b) on the surface of any active runway, and (c) on any taxiway proximate the intersection of the taxiway and any active runway, said system comprising
a first computer with an electronic database having stored data defining each runway and taxiway dimensions, location, and orientation for a specific airport and having a means for generating a graphical depiction of a specific runway and its intersecting taxiways;
a second computer having a means for receiving, comparing, and synthesizing signals indicating the position of an aircraft, said signals received from a plurality of sources, including but not limited to ground control radar, tower control radar, Airport Surface Detection Equipment (ASDE-X), Automatic Dependent Surveillance-Broadcast (ADS-B), aircraft transponders, air traffic controller stations, satellite transmissions, and other equipment to be developed;
a processor, located at a central on-airport facility, being configured with a means for receiving and transforming the synthesized signals received by said second computer into electronic or graphic images displayable on a monitor; and
a plurality of monitors electronically and/or electrically coupled to said processor, the monitors being located proximate the intersections of a specific runway and its associated taxiways, and if existent, the intersection of the runway with other runways, said monitors easily visible and readable by pilots of taxiing aircraft.

4. A system as in any of claims 1, 2, or 3, wherein at least one of said processors is located proximate each of the airport runways.

5. A system as in any of claims 1,2, or 3 wherein said monitor displays are in the approximate size of two feet (2.0′) vertically by four feet (4.0′) horizontally.

6. A method of providing information of aircraft, and/or vehicular movement on active runways and runway/taxiway intersections, comprising the steps of generating a graphical depiction of a specific runway and its intersecting taxiways; detecting the aircraft and/or vehicular positions and movements occurring within a certain distance of said runway and taxiways; transforming the detected positions and movements into electronic or graphic images displayable on a monitor; and providing a plurality of said monitors located proximate the intersections of a specific runway and its associated taxiways, said monitors presenting said images and graphics in clearly visible and readable form for pilots of taxiing aircraft.
